(19) United States
(12) Patent Application Publication
(10) Pub. No.: US 2008/0234070 A1
(43) Pub. Date: Sep. 25, 2008

(54) Functionalized, Crosslinked, Rubber Nanoparticles for Use in Golf Ball Intermediate Layers

(76) Inventors: Brian Comeau, Berkley, MA (US); Murali Rajagopalan, South Dartmouth, MA (US); Michael J. Sullivan, Barrington, RI (US)

Correspondence Address: ACUSHNET COMPANY, 333 BRIDGE STREET, P. O. BOX 965, FAIRHAVEN, MA, 02719, US

(21) Appl. No.: 11/690,350

(22) Filed: Mar. 23, 2007

(51) Int. Cl. A63B 37/12; B29B 7/00

(52) U.S. Cl. 473/378; 264/319; 264/328.1; 524/196; 524/186; 524/114; 524/394

(57) ABSTRACT

A golf ball including a core; an outer cover layer; and an inner cover layer disposed between the core and outer cover layer, the inner cover layer being formed from a polymer blend including a microgel having a Tg of 20° C. or greater formed from a monomer, a co-monomer, and an initiator; and a thermoplastic material.

### FIELD OF THE INVENTION

The present invention is directed to golf ball compositions and, in particular, the use of crosslinked rubber nanoparticles in golf ball layers, such as outer covers, intermediate layers, and cores.

### BACKGROUND OF THE INVENTION

Conventional golf balls can be divided into two general constructions: solid and wound. Solid golf balls include one-piece, two-piece (i.e., solid core and a cover), and multi-layer (i.e., solid core of one or more layers and/or a cover of one or more layers) golf balls. Wound golf balls typically include a solid, hollow, or fluid-filled center, surrounded by a tensioned elastomeric material, and one or more cover layers. Solid balls have traditionally been considered longer and more durable than wound balls, but some solid constructions allegedly lack the “feel” provided by the wound construction—this deficiency is typically noticed by more advanced players.

By altering ball construction and composition, manufacturers have been able to vary a wide range of playing characteristics, such as compression, velocity, “feel,” and spin, optimizing each or all for various playing abilities. In particular, a variety of core constructions, such as multi-layer balls having multiple cover layers and/or core layers, have been investigated and now allow many solid golf balls to exhibit characteristics previously achieved solely with a wound construction. These solid layers are typically formed from a number of thermoset or thermoplastic polymeric compositions and blends, including polybutadiene rubbers, polyurethanes, ethylene-based ionomers, and polyureas.

There is a need, however, for a means of altering the physical and mechanical properties of conventional golf ball layer materials, such as those discussed above. Commonly, manufacturers will attempt to improve one material property which, unfortunately, has a deleterious effect on one or more different material properties. Therefore, compositions in which unconventional properties may be imparted on a particular material or in which material properties may be altered without adversely affecting other desirable properties, are of importance. The present invention describes such compositions and there use in a variety of golf ball core and cover layers.

### SUMMARY OF THE INVENTION

The present invention is directed to a golf ball comprising a core; an outer cover layer; and an inner cover layer disposed between the core and outer cover layer, the inner cover layer comprising a polymer blend comprising a microgel having a T_{g} of 20° C. or greater formed from a monomer, a co-monomer, and an initiator; and a thermoplastic material.

The thermoplastic material is typically a conventional ionomer or a fully-neutralized ionomer. The microgel may be unfunctionalized or it can be functionalized with a reactive group, such as hydroxyl, anhydrides, epoxies, isocyanates, amines, acids, amides, or nitrites. In a preferred embodiment, the microgel surface is functionalized with anhydride, hydroxyl, amines, isocyanates, or epoxy groups.

The cover may be formed in any manner, but is preferably injection molded, cast, reaction injection molded, or compression molded, and generally has material hardness of 60 Shore D or less.

The monomer used to form the microgel may include butadiene, styrene, esters of acrylic or methacrylic acid, acrylic or methacrylic acid, hydroxyethyl acrylate or hydroxyethyl methacrylate, or hydroxybutyl acrylate or hydroxybutyl methacrylate. The co-monomer, however, includes neopentyl glycol, trimethylol propane, pentaerythritol, triallyl trimellitate, divinyl benzene, di and triacrylates including urethane or urea diacrylate or methacrylate and triacrylate or methacrylate, or hydroxyl terminated polybutadiene. The initiator includes dicumyl peroxide; t-butylcumyl peroxide; bis-(t-butylperoxyisopropyl)benzene; di-t-butyl peroxide; 2,5-dimethylhexane-2,5-dihydroperoxide; 2,5-dimethylhexyne-3,2,5-dihydroperoxide; dibenzoyl peroxide; bis-(2,4-dichlorobenzoyl)peroxide; t-butyl perbenzoate; organic azo compounds; di- and polymercapto compounds; or mercapto-terminated polysulfide rubbers. Preferably, the initiator includes dicumyl peroxide; t-butylcumyl peroxide; bis-(t-butylperoxyisopropyl)benzene; or di-t-butyl peroxide.

The glass transition temperature (T_{g}) of the microgels typically ranges from 40° C. to 70° C., and the microgels have a swelling index in toluene at 23° C. of 40 or less. The microgels have an average particle diameter of 5 nm to 500 nm, more preferably 40 nm to 100 nm.

In one embodiment, he core comprises a polybutadiene material or a fully-neutralized ionomer. In an alternative embodiment, the core has an Atti compression of 50 to 100 and at least one of the inner cover layer or outer cover layer has a thickness of 0.020 inches to 0.045 inches.

The present invention is also directed to a golf ball comprising a core comprising a center and an outer core layer, at lease one of the center or outer core layers comprising a polybutadiene rubber material or a fully-neutralized ionomeric material; a castable polyurea or polyurethane outer cover layer having a thickness of 0.02 inches to 0.06 inches; and an inner cover layer disposed between the core and outer cover layer, the inner cover layer having a thickness of 0.015 inches to 0.06 inches and comprising a polymer blend comprising a microgel having a Tg of 20° C. to 100° C. formed from a monomer, a co-monomer, and an initiator; and a thermoplastic material, wherein the microgel is present in an amount of 2.5 phr to 25 phr and the outer core layer optionally comprises the microgel.

The present invention is further directed to a golf ball comprising a core comprising a polybutadiene rubber material or a fully-neutralized ionomeric material; a castable polyurea or polyurethane outer cover layer having a thickness of 0.02 inches to 0.06 inches; and an inner cover layer disposed between the core and outer cover layer, the inner cover layer having a thickness of 0.015 inches to 0.06 inches and comprising a polymer blend comprising a second microgel having a Tg of 20° C. to 100° C. formed from a second monomer, a co-monomer, and a second initiator; and a thermoplastic material, wherein the microgel is present in an amount of 2.5 phr to 25 phr.

### DETAILED DESCRIPTION OF THE INVENTION

The present invention is directed to the use of insoluble crosslinked rubber particles in golf ball compositions, preferably rubber compositions such as those used in core formulations, to improve processability, adjust density (i.e., shift the moment of inertia), and alter the elasticity or plasticity of crosslinked (and vulcanized) compound, for example. The insoluble crosslinked particles, called microgels, are typically formed from the combination of a monomer (i.e., a butadiene monomer), a co-monomer (i.e., an ester of acrylic and methacrylic acid), and an initiator (i.e., a peroxide) to form a reactive nanomaterial that is available for blending with a thermoplastic or thermoset polymer or rubber matrix.

Generally, the microgels of the invention may be formed a variety of ways including, but not limited to, emulsion polymerization, solution polymerization, and slurry polymerization.

The preferred method of microgel formation is emulsion polymerization. For example, for microgels prepared by emulsion polymerization, radically polymerizable monomers are used, such as butadiene, styrene, acrylonitrile, isoprene, esters of acrylic and methacrylic acid, tetrafluoroethylene, vinylidene fluoride, hexafluoropropene, 2-chlorobutadiene, 2,3-dichlorobutadiene, and double bond-containing carboxylic acids (such as acrylic acid, methacrylic acid, maleic acid, itaconic acid, etc.), double bond-containing hydroxyl compounds (such as hydroxyethyl methacrylate, hydroxyethyl acrylate, hydroxybutyl methacrylate, etc.), amine-functionalized (meth)acrylates, acrolein, N-vinyl-2-pyrollidone, N-allyl urea and N-allyl thiourea, secondary amino(meth)acrylic acid esters (such as 2-t-butyl aminoethyl methacrylate and 2-t-butyl aminoethyl methacrylamide, etc.). A preferred monomer is butadiene monomer.

The rubber gel can be crosslinked directly during emulsion polymerization by copolymerization with polyfunctional compounds (a co-monomer) having a crosslinking action, or by subsequent crosslinking. Direct crosslinking during emulsion polymerization is preferred. Suitable polyfunctional comonomers are compounds having at least two, preferably 2 to 4 copolymerizable C═C double bonds, such as diisopropenyl benzene, divinyl benzene, divinyl ether, divinyl sulfone, diallyl phthalate, triallyl cyanurate, triallyl isocyanurate, 1,2-polybutadiene, N,N′-m-phenylene maleimide, 2,4-toluylene bis(maleimide), and triallyl trimellitate. Also suitable are the acrylates and methacrylates of polyhydric, preferably dihydric to tetrahydric C₂ to C₁₀ alcohols, such as ethylene glycol, propanediol-1,2, butanediol, hexanediol, polyethylene glycol having 2 to 20, preferably 2 to 8 oxyethylene units, neopentyl glycol, bisphenol A, glycerol, trimethylol propane, pentaerythritol, sorbitol with unsaturated polyesters of aliphatic diols and polyols and maleic acid, fumaric acid, and itaconic acid.

The latices obtained in the emulsion polymerisation are ideally used for crosslinking the uncrosslinked or weakly crosslinked microgel starting products following emulsion polymerisation. Natural rubber latices can also be crosslinked in this way.

Suitable chemicals having a crosslinking action include organic peroxides, such as dicumyl peroxide, t-butylcumyl peroxide, bis-(t-butylperoxyisopropyl)benzene, di-t-butyl peroxide, 2,5-dimethylhexane-2,5-dihydroperoxide, 2,5-dimethylhexyne-3,2,5-dihydroperoxide, dibenzoyl peroxide, bis-(2,4-dichlorobenzoyl)peroxide, t-butyl perbenzoate; organic azo compounds, such as azo-bis-isobutyronitrile and azo-bis-cyclohexane nitrile; di- and polyinercapto compounds, such as dimercaptoethane, 1,6-dimercaptohexane, 1,3,5-trimercaptotriazine; and mercapto-terminated polysulfide rubbers, such as mercapto-terminated reaction products of bis-chloroethylformal with sodium polysulfide.

Suitable microgels include, but are not limited to, crosslinked microgels based on homopolymers or random copolymers. These microgels are typically present in an amount of about 1 phr to about 60 phr of the polymer composition, and preferably have an almost spherical geometry. Preferred particle size of the microgels are about 5 nm to about 200 nm, more preferably about 15 nm to about 150 nm, and most preferably about 30 nm to about 100 nm. A suitable commercially-available microgel is MICROMORPH® from Rhein-Chemie.

In the composition according to the invention the microgels that are used conveniently have glass transition temperatures T_{g} of about −100° C. to about 100° C., more preferably about −80° C. to about 80° C. In one embodiment, microgels have a glass transition temperature (T_{g}) of greater than 5° C., preferably greater than 10° C., more preferably greater than 20° C. In an alternative and preferred embodiment, the microgels have a T_{g} of about −100° C. to about 0° C., more preferably about −90° C. to about −15° C., most preferably about −85° C. to about −50° C. Microgels of this nature are generally not completely homogeneously crosslinked meaning that the modulus change from the matrix phase to the dispersed phase is not direct. Therefore, impact stress does not lead to tearing effects between the matrix and the dispersed phase. As a result, mechanical properties, such as swelling behavior and stress corrosion cracking, are advantageously influenced. It is believed that a change in T_{g} directly affects elasticity and, therefore, core (and golf ball) performance. A composition having a low T_{g} is likely to have a higher elasticity (the composition is more rubber-like) whereas a composition having a higher T_{g} is likely to have a lower elasticity (the composition is more plastic-like).

The glass transition temperature (T_{g}) and the glass transition temperature range (ΔT_{g}) of the microgels are determined by means of differential scanning calorimetry (“DSC”). To determine T_{g} and ΔT_{g}, two cooling/heating cycles are performed and T_{g} and ΔT_{g} are determined in the second heating cycle. For the measurements, 10-12 mg of microgel is placed in a DSC sample container. The first DSC cycle is performed by cooling the sample to −100° C. and then heating it at a rate of 20 K/min to +150° C. The second DSC cycle is begun by cooling the sample as soon as a sample temperature of +150° C. is reached. Cooling takes place at a rate of approximately 320 K/min. In the second heating cycle, the sample is heated again to +150° C. The heating rate in the second cycle is 20 K/min. T_{g} and ΔT_{g} are graphically determined on the DSC curve of the second heating operation. For this purpose three straight lines are plotted on the DSC curve. The first straight line is plotted on the section of the DSC curve below T_{g}, the second straight line on the part of the curve passing through T_{g} with the turning point, and the third straight line on the part of the DSC curve above T_{g}. Three straight lines with two points of intersection are obtained in this way. Each point of intersection is characterized by a temperature. The glass transition temperature T_{g} is obtained as the average of these two temperatures and the glass transition range ΔT_{g} is obtained as the difference between the two temperatures.

Unmodified microgels, which have no (or relatively few) surface reactive groups, and microgels modified with functional groups, can be used to produce the compositions according to the invention. Modified microgels can be produced by a chemical reaction of the microgels with chemicals that react with C═C double bonds. These reactive chemicals include, but are not limited to, compounds having polar groups, such as aldehyde, hydroxyl, carboxyl, nitrile; sulfur-containing groups, such as mercapto, dithiocarbamate, polysulfide, xanthogenate, thiobenzothiazole, and dithiophosphoric acid groups; and unsaturated dicarboxylic acid groups. Microgel modification can improve its compatibility with the rubber (or polymer) matrix, in order to obtain good dispersibility. In a preferred embodiment, the microgels have hydroxyl groups on the surface that allow blending with typically incompatible cast polymers. Additional preferred functional groups include, but are not limited to, —NH and —NCO. Surface hydroxyl groups provide a surface functionality that is somewhat hydrophilic which allows for compatibility and reaction with the polymer matrix. These reactive groups also provide a sufficient amount of reactive moieties that can further react with reactive groups in castable materials.

In one embodiment, preferred modification methods include grafting of functional monomers to the microgel surface, followed by reaction with low-molecular-weight agents. The amount of modifying agent used depends on its efficiency and on the requirements specified in the individual case and ranges from 0.05 to 30 percent by weight, based on the total amount of rubber microgel, more preferably 0.5 to 10 percent by weight.

The average diameter of the microgels produced can be set with a high degree of accuracy, such that a particle size distribution is achieved in which at least 75% of all microgel particles are between 0.095 μm and 0.105 μm in size. Other average diameters of the microgels, such as 5 nm to 500 nm, can be established with the same accuracy. In this way the morphology of the microgels dispersed in the composition according to the invention can be pinpointed almost exactly and the properties of the compositions of the invention can be set. Preferred microgel properties and precursors are disclosed in U.S. Patent Application Serial No. 2006/0254734, which is incorporated herein, in its entirety.

In one embodiment, the microgels, as described above, are used to form a rubber-based composition for use in golf ball cores and core layers, the composition comprising at least one diene rubber; at least one unsaturated carboxylic acid or a salt thereof; at least one peroxide; and at least one microgel. In another preferred embodiment, the microgels, as described above, are used to form a thermoplastic-based composition for use in golf ball layers, such as intermediate layers and inner cover layers, the composition comprising at least one thermoplastic polymer and at least one microgel. In an alternative embodiment, the microgels, as described above, are used to form a castable thermoset-based composition for use in golf ball layers, such as outer cover layers, the composition comprising at least one castable thermoset polymer and at least one microgel.

Suitable diene rubbers include, but are not limited to, natural rubber, styrene/isoprene/butadiene rubber, polybutadiene rubber, styrene/butadiene/acrylonitrile rubber, polychloroprene, butadiene/acrylic acid C₁₋₄ alkyl ester copolymers, polyisoprene, styrene-butadiene copolymers, carboxylated styrene-butadiene copolymers, fluororubber, acrylate rubber, polybutadiene-acrylonitrile copolymers, carboxylated nitrile rubbers, isobutylene/isoprene copolymers, brominated isobutylene/isoprene copolymers, chlorinated isobutylene/isoprene copolymers, ethylene/propylene copolymers, ethylene-propylene-diene copolymers, ethylene/acrylate copolymers, ethylene/vinyl acetate copolymers, epichlorohydrin rubbers, silicone rubbers, polyester urethane polymers, polyether urethane polymers, epoxydised natural rubber, or mixtures thereof.

Preferred diene rubbers include natural rubber, styrene/butadiene rubber, polyisoprene rubber, styrene/isoprene/butadiene rubber, polybutadiene rubber, nitrile rubber, butyl rubber, styrene/butadiene/acrylonitrile rubber and polychloroprene. In a more preferred embodiment, the diene rubber is polybutadiene, preferably one having a 1,4-cis content >90%. Polybutadiene rubbers are typically produced with the aid of Ziegler catalysts such as Ti, Ni, Co and Nd.

Suitable unsaturated carboxylic acids or a salts thereof include, but are not limited to, metal diacrylates or metal dimethacrylates. The unsaturated carboxylic acid is preferably an α,β-ethylene-unsaturated carboxylic acid having 3 to 8 carbon atoms, such as methacrylic acid, acrylic acid, cinnamic acid, and crotonic acid, of which acrylic acid and methacrylic acid are preferred Suitable metal salts include sodium, potassium, magnesium, calcium, zinc, barium, aluminium, tin, zirconium, lithium, of which sodium, zinc and magnesium are preferred. Zinc diacrylate and zinc dimethacrylate are most preferred. In the compositions according to the invention, 5 to 70 phr of one or more unsaturated carboxylic acids or the salts thereof are preferably used, more preferably 15 to 50 phr. It is also possible to incorporate the unsaturated carboxylic acid and a metal oxide into the compositions.

Suitable peroxides include, but are not limited to, organic peroxides, such as dicumyl peroxide; t-butylcumyl peroxide; bis-(t-butylperoxyisopropyl)benzene; di-t-butyl peroxide; 2,5-dimethylhexane-2,5-dihydroperoxide; 2,5-dimethylhexyne-3,2,5-dihydroperoxide; dibenzoyl peroxide; bis-(2,4-dichlorobenzoyl)peroxide; t-butyl perbenzoate; 4,4-di-(t-butylperoxy)valeric acid butyl ester; and 1,1-bis-(t-butylperoxy)-3,3,5-trimethyl cyclohexane. The peroxide is preferably present in an amount of about 0.2 to about 10 phr, more preferably about 0.2 phr to about 5 phr, and most preferably about 0.2 to about 2 phr.

The compositions of the present invention may also include an optional additive. Suitable additives include, but are not limited to, fillers, such as carbon black, silica, calcium oxide, barium sulfate, titanium dioxide, zinc oxide, peptising agents, stearic acid, accelerators, antiozonants, antioxidants, processing oils, activators, plasticisers, scorch inhibitors, and extender oils. Preferably, the additives are present in an amount of about 0 phr to about 50 phr.

When the rubber compositions containing the microgels are blended with other conventional golf ball layer materials, the resultant blend now contains rubber particles (which can be relatively hydrophobic) that affect the water vapor transition properties and the hardness of the material. These blended materials can be used to form golf ball outer core layers, inner cover layers, or outer cover layers. If used in the outer cover layer, the composition should be present in an amount of about 10% or less, preferably about 7% or less. In a preferred embodiment, the rubber composition containing the microgels are blended in a material for an inner cover layer. In a particularly preferred embodiment, the selected microgels are of the higher Tg variety to impart more plastic-like properties to the layer (i.e., stiffness).

An alternative embodiment includes production of the microgels by emulsion polymerization of radically polymerizable monomers, such as butadiene, in the presence of dimeric ionic monomers, such as metallic acrylates (i.e., zinc diacrylate), an emulsifier, and a suitable initiator, such as a peroxide. Typically, when the polymerization reaches 95% completion or greater, the reaction is terminated by the addition of diethyl hydroxylamine. The gels are then filtered and dried for use in golf ball layer blends. The resultant microgels are ionically cross-linked (as opposed to the above-described microgels which tend to be absent of ionic interactions).

Other suitable materials for blending with the microgels include highly-neutralized polymers (“HNP”). The acid moieties of the HNP's, typically ethylene-based ionomers, are preferably neutralized greater than about 70%, more preferably greater than about 90%, and most preferably at least about 100%. The HNP's can be also be blended with a second polymer component, which, if containing an acid group, may be neutralized in a conventional manner, by the organic fatty acids of the present invention, or both. The second polymer component, which may be partially or fully neutralized, preferably comprises ionomeric copolymers and terpolymers, ionomer precursors, thermoplastics, polyamides, polycarbonates, polyesters, polyurethanes, polyureas, thermoplastic elastomers, polybutadiene rubber, balata, metallocene-catalyzed polymers (grafted and non-grafted), single-site polymers, high-crystalline acid polymers, cationic ionomers, and the like. HNP polymers typically have a material hardness of between about 20 and about 80 Shore D, and a flexural modulus of between about 3,000 psi and about 200,000 psi.

HNP's are ionomers and/or their acid precursors that are preferably neutralized, either fully or partially, with organic acid copolymers or the salts thereof. The acid copolymers are preferably α-olefin, such as ethylene, C₃₋₈ α,β-ethylenically unsaturated carboxylic acid, such as acrylic and methacrylic acid, copolymers. They may optionally contain a softening monomer, such as alkyl acrylate and alkyl methacrylate, wherein the alkyl groups have from 1 to 8 carbon atoms.

The acid copolymers can be described as E/X/Y copolymers where E is ethylene, X is an α,β-ethylenically unsaturated carboxylic acid, and Y is a softening comonomer. In a preferred embodiment, X is acrylic or methacrylic acid and Y is a C₁₋₈ alkyl acrylate or methacrylate ester. X is preferably present in an amount from about 1 to about 35 weight percent of the polymer, more preferably from about 5 to about 30 weight percent of the polymer, and most preferably from about 10 to about 20 weight percent of the polymer. Y is preferably present in an amount from about 0 to about 50 weight percent of the polymer, more preferably from about 5 to about 25 weight percent of the polymer, and most preferably from about 10 to about 20 weight percent of the polymer.

Specific acid-containing ethylene copolymers include, but are not limited to, ethylene/acrylic acid/n-butyl acrylate, ethylene/methacrylic acid/n-butyl acrylate, ethylene/methacrylic acid/iso-butyl acrylate, ethylene/acrylic acid/iso-butyl acrylate, ethylene/methacrylic acid/n-butyl methacrylate, ethylene/acrylic acid/methyl methacrylate, ethylene/acrylic acid/methyl acrylate, ethylene/methacrylic acid/methyl acrylate, ethylene/methacrylic acid/methyl methacrylate, and ethylene/acrylic acid/n-butyl methacrylate. Preferred acid-containing ethylene copolymers include, ethylene/methacrylic acid/n-butyl acrylate, ethylene/acrylic acid/n-butyl acrylate, ethylene/methacrylic acid/methyl acrylate, ethylene/acrylic acid/ethyl acrylate, ethylene/methacrylic acid/ethyl acrylate, and ethylene/acrylic acid/methyl acrylate copolymers. The most preferred acid-containing ethylene copolymers are, ethylene/(meth) acrylic acid/n-butyl, acrylate, ethylene/(meth)acrylic acid/ethyl acrylate, and ethylene/(meth) acrylic acid/methyl acrylate copolymers.

Ionomers are typically neutralized with a metal cation, such as Li, Na, Mg, or Zn. It has been found that by adding sufficient organic acid or salt of organic acid, along with a suitable base, to the acid copolymer or ionomer, however, the ionomer can be neutralized, without losing processability, to a level much greater than for a metal cation. Preferably, the acid moieties are neutralized greater than about 80%, preferably from 90-100%, most preferably 100% without losing processability. This accomplished by melt-blending an ethylene α,β-ethylenically unsaturated carboxylic acid copolymer, for example, with an organic acid or a salt of organic acid, and adding a sufficient amount of a cation source to increase the level of neutralization of all the acid moieties (including those in the acid copolymer and in the organic acid) to greater than 90%, (preferably greater than 100%).

Suitable organic acids include aliphatic, mono- or multi-functional (saturated, unsaturated, or multi-unsaturated) organic acids. Salts of these organic acids may also be employed. The salts of organic acids of the present invention include the salts of barium, lithium, sodium, zinc, bismuth, chromium, cobalt, copper, potassium, strontium, titanium, tungsten, magnesium, cesium, iron, nickel, silver, aluminum, tin, or calcium, salts of fatty acids, particularly stearic, behenic, erucic, oleic, linoelic or dimerized derivatives thereof. It is preferred that the organic acids and salts of the present invention be relatively non-migratory (they do not bloom to the surface of the polymer under ambient temperatures) and non-volatile (they do not volatilize at temperatures required for melt-blending).

The acid copolymers are prepared from ‘direct’ acid copolymers, copolymers polymerized by adding all monomers simultaneously, or by grafting of at least one acid-containing monomer onto an existing polymer.

Thermoplastic polymer components, such as copolyetheresters, copolyesteresters, copolyetheramides, elastomeric polyolefins, styrene diene block copolymers and their hydrogenated derivatives, copolyesteramides, thermoplastic polyurethanes, such as copolyetherurethanes, copolyesterarethanes, copolyureaurethanes, epoxy-based polyurethanes, polycaprolactone-based polyurethanes, polyureas, and polycarbonate-based polyurethanes fillers, and other ingredients, if included, can be blended in either before, during, or after the acid moieties are neutralized, thermoplastic polyurethanes.

The copolyetheresters are comprised of a multiplicity of recurring long chain units and short chain units joined head-to-tail through ester linkages, the long chain units being represented by the formula:

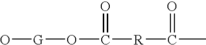

and the short chain units being represented by the formula:

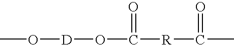

where G is a divalent radical remaining after the removal of terminal hydroxyl groups from a poly (alkylene oxide) glycol having a molecular weight of about 400-8000 and a carbon to oxygen ratio of about 2.0-4.3; R is a divalent radical remaining after removal of hydroxyl groups from a diol having a molecular weight less than about 250; provided said short chain ester units amount to about 15-95 percent by weight of said copolyetherester. The preferred copolyetherester polymers are those where the polyether segment is obtained by polymerization of tetrahydrofuran and the polyester segment is obtained by polymerization of tetramethylene glycol and phthalic acid. The molar ether:ester ratio can vary from 90:10 to 10:80; preferably 80:20 to 60:40; and the Shore D hardness is less than 70; preferably less than about 40.

The copolyetheramides are comprised of a linear and regular chain of rigid polyamide segments and flexible polyether segments, as represented by the general formula:

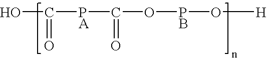

wherein PA is a linear saturated aliphatic polyamide sequence formed from a lactam or amino acid having a hydrocarbon chain containing 4 to 14 carbon atoms or from an aliphatic C₆-C₈ diamine, in the presence of a chain-limiting aliphatic carboxylic diacid having 4-20 carbon atoms; said polyamide having an average molecular weight between 300 and 15,000; and PB is a polyoxyalkylene sequence formed from linear or branched aliphatic polyoxyalkylene glycols, mixtures thereof or copolyethers derived therefrom, said polyoxyalkylene glycols having a molecular weight of less than or equal to 6000; and n indicates a sufficient number of repeating units so that said polyetheramide copolymer has an intrinsic viscosity of from about 0.6 to about 2.05. The preparation of these polyetheramides comprises the step of reacting a dicarboxylic polyamide, the COOH groups of which are located at the chain ends, with a polyoxyalkylene glycol hydroxylated at the chain ends, in the presence of a catalyst such as a tetra-alkyl ortho titanate having the general formula Ti(OR)ₓ wherein R is a linear branched aliphatic hydrocarbon radical having 1 to 24 carbon atoms. Again, the more polyether units incorporated into the copolyetheramide, the softer the polymer. The ether:amide ratios are as described above for the ether:ester ratios, as is the Shore D hardness.

The elastomeric polyolefins are polymers composed of ethylene and higher primary olefins such as propylene, hexene, octene, and optionally 1,4-hexadiene and or ethylidene norbornene or norbornadiene. The elastomeric polyolefins can be optionally functionalized with maleic anhydride, epoxy, hydroxy, amine, carboxylic acid, sulfonic acid, or thiol groups.

Thermoplastic polyurethanes are linear or slightly chain branched polymers consisting of hard blocks and soft elastomeric blocks. They are produced by reacting soft hydroxy terminated elastomeric polyethers or polyesters with diisocyanates, such as methylene diisocyanate (“MDI”), p-phenylene diisocyanate (“PPDI”), or toluene diisocyanate (“TDI”). These polymers can be chain extended with glycols, secondary diamines, diacids, or amino alcohols. The reaction products of the isocyanates and the alcohols are called urethanes and these blocks are relatively hard and high melting. These hard high melting blocks are responsible for the thermoplastic nature of the polyurethanes.

Block styrene diene copolymers and their hydrogenated derivatives are composed of polystyrene units and polydiene units. They may also be functionalized with moieties such as OH, NH₂, epoxy, COOH, and anhydride groups. The polydiene units are derived from polybutadiene, polyisoprene units or copolymers of these two. In the case of the copolymer it is possible to hydrogenate the polyolefin to give a saturated rubbery backbone segments. These materials are usually referred to as SBS, SIS, or SEBS thermoplastic elastomers and they can also be functionalized with maleic anhydride.

The HNP's may also be blended with high crystalline acid copolymers and their ionomer derivatives (which may be neutralized with conventional metal cations or the organic fatty acids and salts thereof) or a blend of a high crystalline acid copolymer and its ionomer derivatives and at least one additional material, preferably an acid copolymer and its ionomer derivatives The HNP's may also be blended with cationic ionomers, such as those disclosed in U.S. Pat. No. 6,193,619 which is incorporated herein by reference The HNP's may also be blended with polyurethane and polyurea ionomers which include anionic moieties or groups, such as those disclosed in U.S. Pat. No. 6,207,784 which is incorporated herein by reference.

The golf balls of the present invention may comprise a variety of constructions. In one embodiment of the present invention, golf ball includes a core, an inner cover layer surrounding the core, and an outer cover layer. Preferably, the core is solid. More preferably, the core is a solid, single-layer core. In one embodiment, the solid core comprises functionalized microgels of the present invention. In an alternative embodiment, the solid core may include compositions having a base rubber, a crosslinking agent, a filler, and a co-crosslinking or initiator agent, and the inner cover layer comprises microgels of the present invention.

The base rubber typically includes natural or synthetic rubbers. A preferred base rubber is 1,4-polybutadiene having a cis-structure of at least 40%. More preferably, the base rubber comprises high-Mooney-viscosity rubber. If desired, the polybutadiene can also be mixed with other elastomers known in the art such as natural rubber, polyisoprene rubber and/or styrene-butadiene rubber in order to modify the properties of the core.

The crosslinking agent includes a metal salt of an unsaturated fatty acid such as a zinc salt or a magnesium salt of an unsaturated fatty acid having 3 to 8 carbon atoms such as acrylic or methacrylic acid. Suitable cross linking agents include metal salt diacrylates, dimethacrylates and monomethacrylates wherein the metal is magnesium, calcium, zinc, aluminum, sodium, lithium or nickel. The crosslinking agent is present in an amount from about 15 to about 30 parts per hundred of the rubber, preferably in an amount from about 19 to about 25 parts per hundred of the rubber and most preferably having about 20 to 24 parts crosslinking agent per hundred of rubber. The core compositions of the present invention may also include at least one organic or inorganic cis-trans catalyst to convert a portion of the cis-isomer of polybutadiene to the trans-isomer, as desired.

The initiator agent can be any known polymerization initiator which decomposes during the cure cycle. Suitable initiators include peroxide compounds such as dicumyl peroxide, 1,1-di-(t-butylperoxy) 3,3,5-trimethyl cyclohexane, a-a bis-(t-butylperoxy)diisopropylbenzene, 2,5-dimethyl-2,5 di-(t-butylperoxy)hexane or di-t-butyl peroxide and mixtures thereof.

Fillers, any compound or composition that can be used to vary the density and other properties of the core, typically include materials such as tungsten, zinc oxide, barium sulfate, silica, calcium carbonate, zinc carbonate, metals, metal oxides and salts, regrind (recycled core material typically ground to about 30 mesh particle), high-Mooney-viscosity rubber regrind, and the like.

The golf ball cores of the present invention may also comprise a variety of constructions. For example, the core may comprise a single layer or a plurality of layers. The core may also comprise a tensioned elastomeric material. In another embodiment of the present invention, golf ball comprises a solid center surrounded by at least one additional solid outer core layer. The “dual” core is surrounded by a “double” cover comprising an inner cover layer and an outer cover layer.

At least one of the outer core layers, if present, is formed of a resilient rubber-based component comprising a high-Mooney-viscosity rubber, and a crosslinking agent present in an amount from about 20 to about 40 parts per hundred, from about 30 to about 38 parts per hundred, and most preferably about 37 parts per hundred. It should be understood that the term “parts per hundred” is with reference to the rubber by weight.

When the golf ball of the present invention includes an intermediate layer, such as an outer core layer or an inner cover layer, any or all of these layer(s) may comprise thermoplastic and thermosetting materials, but preferably the intermediate layer(s), if present, comprise ionic copolymers of ethylene and an unsaturated monocarboxylic acid which are available under the trademark SURLYN® of E.I. DuPont de Nemours & Co., of Wilmington, Del., or IOTEK® or ESCOR® of Exxon. In a preferred embodiment, these ionomers are blended with the microgels of the present invention. These ionomers are copolymers or terpolymers of ethylene and methacrylic acid or acrylic acid partially neutralized with salts of zinc, sodium, lithium, magnesium, potassium, calcium, manganese, nickel or the like, in which the salts are the reaction product of an olefin having from 2 to 8 carbon atoms and an unsaturated monocarboxylic acid having 3 to 8 carbon atoms. The carboxylic acid groups of the copolymer may be totally or partially neutralized and might include methacrylic, crotonic, maleic, fumaric or itaconic acid.

The ionomers of the invention may also be partially neutralized with metal cations. The acid moiety in the acid copolymer is neutralized about 1 to about 100%, preferably at least about 40 to about 100%, and more preferably at least about 90 to about 100%, to form an ionomer by a cation such as lithium, sodium, potassium, magnesium, calcium, barium, lead, tin, zinc, aluminum, or a mixture thereof.

One preferred embodiment is a low-T_{g} embodiment and includes a blend of microgels to conventionally-tougher materials, such as ionomers, to impart more rubber-like properties (i.e., toughness and flexibility).

This golf ball can likewise include one or more homopolymeric or copolymeric inner cover materials, which may or may not be blended with the microgels of the invention, such as:
(1) Vinyl resins, such as those formed by the polymerization of vinyl chloride, or by the copolymerization of vinyl chloride with vinyl acetate, acrylic esters or vinylidene chloride;
(2) Polyolefins, such as polyethylene, polypropylene, polybutylene and copolymers such as ethylene methylacrylate, ethylene ethylacrylate, ethylene vinyl acetate, ethylene methacrylic or ethylene acrylic acid or propylene acrylic acid and copolymers and homopolymers produced using a single-site catalyst or a metallocene catalyst;
(3) Polyurethanes, such as those prepared from polyols and diisocyanates or polyisocyanates, in particular PPDI-based thermoplastic polyurethanes, and those disclosed in U.S. Pat. No. 5,334,673;
(4) Polyureas, such as those disclosed in U.S. Pat. No. 5,484,870;
(5) Polyamides, such as poly(hexamethylene adipamide) and others prepared from diamines and dibasic acids, as well as those from amino acids such as poly(caprolactam), and blends of polyamides with SURLYN®, polyethylene, ethylene copolymers, ethylene-propylene-non-conjugated diene terpolymer, and the like;
(6) Acrylic resins and blends of these resins with poly vinyl chloride, elastomers, and the like;
(7) Thermoplastics, such as urethane; olefinic thermoplastic rubbers, such as blends of polyolefins with ethylene-propylene-non-conjugated diene terpolymer; block copolymers of styrene and butadiene, isoprene or ethylene-butylene rubber; or copoly(ether-amide), such as PEBAX®, sold by ELF Atochem of Philadelphia, Pa.;
(8) Polyphenylene oxide resins or blends of polyphenylene oxide with high impact polystyrene as sold under the trademark NORYL® by General Electric Company of Pittsfield, Mass.;
(9) Thermoplastic polyesters, such as polyethylene terephthalate, polybutylene terephthalate, polyethylene terephthalate/glycol modified, poly(trimethylene terepthalate), and elastomers sold under the trademarks HYTREL® by E.I. DuPont de Nemours & Co. of Wilmington, Del., and LOMOD® by General Electric Company of Pittsfield, Mass.;
(10) Blends and alloys, including polycarbonate with acrylonitrile butadiene styrene, polybutylene terephthalate, polyethylene terephthalate, styrene maleic anhydride, polyethylene, elastomers, and the like, and polyvinyl chloride with acrylonitrile butadiene styrene or ethylene vinyl acetate or other elastomers; and
(11) Blends of thermoplastic rubbers with polyethylene, propylene, polyacetal, nylon, polyesters, cellulose esters, and the like.

The cover layer, which can be formed of any of the above listed materials, preferably includes polymers, such as ethylene, propylene, butene-1 or hexane-1 based homopolymers or copolymers including functional monomers, such as acrylic and methacrylic acid and fully or partially neutralized ionomer resins and their blends, methyl acrylate, methyl methacrylate homopolymers and copolymers, imidized, amino group containing polymers, polycarbonate, reinforced polyamides, polyphenylene oxide, high impact polystyrene, polyether ketone, polysulfone, poly(phenylene sulfide), acrylonitrile-butadiene, acrylic-styrene-acrylonitrile, polyethylene terephthalate), poly(butylene terephthalate), polyvinyl alcohol), poly(tetrafluoroethylene) and their copolymers including functional comonomers, and blends thereof. Suitable cover compositions also include a polyether or polyester thermoplastic urethane, a thermoset polyurethane, a low modulus ionomer, such as acid-containing ethylene copolymer ionomers, including E/X/Y terpolymers where E is ethylene, X is an acrylate or methacrylate-based softening comonomer present in about 0 to 50 weight percent and Y is acrylic or methacrylic acid present in about 5 to 35 weight percent. More preferably, in a low spin rate embodiment designed for maximum distance, the acrylic or methacrylic acid is present in about 16 to 35 weight percent, making the ionomer a high modulus ionomer. In a higher spin embodiment, the inner cover layer includes an ionomer where an acid is present in about 10 to 15 weight percent and includes a softening comonomer. Additionally, high-density polyethylene (“HDPE”), low-density polyethylene (“LDPE”), LLDPE, and homo- and co-polymers of polyolefin are suitable for a variety of golf ball layers.

In one embodiment, the outer cover preferably includes a polyurethane or polyurea composition comprising the reaction product of at least one polyisocyanate, polyol, and at least one curing agent, and blended with the microgels of the invention (rubber, functionalized, etc.). Any polyisocyanate available to one of ordinary skill in the art is suitable for use according to the invention. Exemplary polyisocyanates include, but are not limited to, 4,4′-diphenylmethane diisocyanate (“MDI”); polymeric MDI; carbodiimide-modified liquid MDI; 4,4′-dicyclohexylmethane diisocyanate; p-phenylene diisocyanate (“PPDI”); m-phenylene diisocyanate; toluene diisocyanate (“TDI”); 3,3′-dimethyl-4,4′-biphenylene diisocyanate; isophoronediisocyanate; hexamethylene diisocyanate (“HDI”); naphthalene diisocyanate; xylene diisocyanate; p-tetramethylxylene diisocyanate; m-tetramethylxylene diisocyanate; ethylene diisocyanate; propylene-1,2-diisocyanate; tetramethylene-1,4-diisocyanate; cyclohexyl diisocyanate; 1,6-hexamethylene-diisocyanate (“HDI”); dodecane-1,12-diisocyanate; cyclobutane-1,3-diisocyanate; cyclohexane-1,3-diisocyanate; cyclohexane-1,4-diisocyanate; 1-isocyanato-3,3,5-trimethyl-5-isocyanatomethylcyclohexane; methyl cyclohexylene diisocyanate; triisocyanate of HDI; triisocyanate of 2,4,4-trimethyl-1,6-hexane diisocyanate; tetracene diisocyanate; napthalene diisocyanate; anthracene diisocyanate; isocyanurate of toluene diisocyanate; uretdione of hexamethylene diisocyanate; and mixtures thereof. Polyisocyanates are known to those of ordinary skill in the art as having more than one isocyanate group, e.g., di-isocyanate, tri-isocyanate, and tetra-isocyanate. Preferably, the polyisocyanate includes MDI, PPDI, TDI, or a mixture thereof, and more preferably, the polyisocyanate includes MDI. It should be understood that, as used herein, the term “MDI” includes 4,4′-diphenylmethane diisocyanate, polymeric MDI, carbodiimide-modified liquid MDI, and mixtures thereof and, additionally, that the diisocyanate employed may be “low free monomer,” understood by one of ordinary skill in the art to have lower levels of “free” monomer isocyanate groups, typically less than about 0.1% free monomer groups. Examples of “low free monomer” diisocyanates include, but are not limited to Low Free Monomer MDI, Low Free Monomer TDI, and Low Free Monomer PPDI.

The at least one polyisocyanate should have less than about 14% unreacted NCO groups. Preferably, the at least one polyisocyanate has no greater than about 7.5% NCO, and more preferably, less than about 7.0%.

Any polyol available to one of ordinary skill in the art is suitable for use according to the invention. Exemplary polyols include, but are not limited to, polyether polyols, hydroxy-terminated polybutadiene (including partially/fully hydrogenated derivatives), polyester polyols, polycaprolactone polyols, and polycarbonate polyols. In one preferred embodiment, the polyol includes polyether polyol. Examples include, but are not limited to, polytetramethylene ether glycol (“PTMEG”), polyethylene propylene glycol, polyoxypropylene glycol, and mixtures thereof. The hydrocarbon chain can have saturated or unsaturated bonds and substituted or unsubstituted aromatic and cyclic groups. Preferably, the polyol of the present invention includes PTMEG.

In another embodiment, polyester polyols are included in the polyurethane material of the invention. Suitable polyester polyols include, but are not limited to, polyethylene adipate glycol; polybutylene adipate glycol; polyethylene propylene adipate glycol; o-phthalate-1,6-hexanediol; poly(hexamethylene adipate) glycol; and mixtures thereof. The hydrocarbon chain can have saturated or unsaturated bonds, or substituted or unsubstituted aromatic and cyclic groups.

In another embodiment, polycaprolactone polyols are included in the materials of the invention. Suitable polycaprolactone polyols include, but are not limited to, 1,6-hexanediol-initiated polycaprolactone, diethylene glycol initiated polycaprolactone, trimethylol propane initiated polycaprolactone, neopentyl glycol initiated polycaprolactone, 1,4-butanediol-initiated polycaprolactone, and mixtures thereof. The hydrocarbon chain can have saturated or unsaturated bonds, or substituted or unsubstituted aromatic and cyclic groups.

In yet another embodiment, the polycarbonate polyols are included in the polyurethane material of the invention. Suitable polycarbonates include, but are not limited to, polyphthalate carbonate and poly(hexamethylene carbonate) glycol. The hydrocarbon chain can have saturated or unsaturated bonds, or substituted or unsubstituted aromatic and cyclic groups. In one embodiment, the molecular weight of the polyol is from about 200 to about 4000.

Polyamine curatives are also suitable for use in polyurethane compositions and have been found to improve cut, shear, and impact resistance of the resultant balls. Preferred polyamine curatives include, but are not limited to, 3,5-dimethylthio-2,4-toluenediamine and isomers thereof; 3,5-diethyltoluene-2,4-diamine and isomers thereof, such as 3,5-diethyltoluene-2,6-diamine; 4,4′-bis-(sec-butylamino)-diphenylmethane; 1,4-bis-(sec-butylamino)-benzene, 4,4′-methylene-bis-(2-chloroaniline); 4,4′-methylene-bis-(3-chloro-2,6-diethylaniline); polytetramethyleneoxide-di-p-aminobenzoate; N,N′-dialkyldiamino diphenyl methane; p,p′-methylene dianiline; m-phenylenediamine; 4,4′-methylene-bis-(2-chloroaniline); 4,4′-methylene-bis-(2,6-diethylaniline); 4,4′-methylene-bis-(2,3-dichloroaniline); 4,4′-diamino-3,3′-diethyl-5,5′-dimethyl diphenylmethane; 2,2′,3,3′-tetrachloro diamino diphenylmethane; trimethylene glycol di-p-aminobenzoate; and mixtures thereof. Preferably, the curing agent of the present invention includes 3,5-dimethylthio-2,4-toluenediamine and isomers thereof, such as ETHACURE 300, commercially available from Albermarle Corporation of Baton Rouge, La. Suitable polyamine curatives, which include both primary and secondary amines, preferably have molecular weights ranging from about 64 to about 2000.

At least one of a diol, triol, tetraol, or hydroxy-terminated curatives may be added to the aforementioned polyurethane composition. Suitable diol, triol, and tetraol groups include ethylene glycol; diethylene glycol; polyethylene glycol; propylene glycol; polypropylene glycol; lower molecular weight polytetramethylene ether glycol; 1,3-bis(2-hydroxyethoxy)benzene; 1,3-bis-[2-(2-hydroxyethoxy)ethoxy]benzene; 1,3-bis-{2-[2-(2-hydroxyethoxy)ethoxy]ethoxy}benzene; 1,4-butanediol; 1,5-pentanediol; 1,6-hexanediol; resorcinol-di-(β-hydroxyethyl)ether; hydroquinone-di-(β-hydroxyethyl)ether; and mixtures thereof. Preferred hydroxy-terminated curatives include 1,3-bis(2-hydroxyethoxy)benzene; 1,3-bis-[2-(2-hydroxyethoxy)ethoxy]benzene; 1,3-bis-{2-[2-(2-hydroxyethoxy)ethoxy]ethoxy}benzene; 1,4-butanediol, and mixtures thereof. Preferably, the hydroxy-terminated curatives have molecular weights ranging from about 48 to 2000. It should be understood that molecular weight, as used herein, is the absolute weight average molecular weight and would be understood as such by one of ordinary skill in the art.

Both the hydroxy-terminated and amine curatives can include one or more saturated, unsaturated, aromatic, and cyclic groups. Additionally, the hydroxy-terminated and amine curatives can include one or more halogen groups. The polyurethane composition can be formed with a blend or mixture of curing agents. If desired, however, the polyurethane composition may be formed with a single curing agent.

In a preferred embodiment of the present invention, saturated polyurethanes are used to form cover layers, preferably the outer cover layer, and may be selected from among both castable thermoset and thermoplastic polyurethanes.

In this embodiment, the saturated polyurethanes of the present invention are substantially free of aromatic groups or moieties. Saturated polyurethanes suitable for use in the invention are a product of a reaction between at least one polyurethane prepolymer and at least one saturated curing agent. The polyurethane prepolymer is a product formed by a reaction between at least one saturated polyol and at least one saturated diisocyanate. As is well known in the art, a catalyst may be employed to promote the reaction between the curing agent and the isocyanate and polyol.

The compositions of the invention may also be polyurea-based and blended with the inventive microgels. Polyureas are distinctly different from polyurethane compositions, but also result in desirable aerodynamic and aesthetic characteristics when used in golf ball components. The polyurea-based compositions may be saturated in nature to aid in resistance to color change upon exposure to UV light.

Without being bound to any particular theory, it is believed that substitution of the long chain polyol segment in the polyurethane prepolymer with a long chain polyamine oligomer soft segment to form a polyurea prepolymer, improves shear, cut, and resiliency, as well as adhesion to other components. Thus, the polyurea compositions of this invention may be formed from the reaction product of an isocyanate and polyamine prepolymer crosslinked with a curing agent. For example, polyurea-based compositions of the invention may be prepared from at least one isocyanate, at least one polyether amine, and at least one diol curing agent or at least one diamine curing agent.

Any polyamine available to one of ordinary skill in the art is suitable for use in the polyurea prepolymer. Polyether amines are particularly suitable for use in the prepolymer. As used herein, “polyether amines” refer to at least polyoxyalkyleneamines containing primary amino groups attached to the terminus of a polyether backbone. Due to the rapid reaction of isocyanate and amine, and the insolubility of many urea products, however, the selection of diamines and polyether amines is limited to those allowing the successful formation of the polyurea prepolymers. In one embodiment, the polyether backbone is based on tetramethylene, propylene, ethylene, trimethylolpropane, glycerin, and mixtures thereof.

Suitable polyether amines include, but are not limited to, methyldiethanolamine; polyoxyalkylenediamines such as, polytetramethylene ether diamines, polyoxypropylenetriamine, and polyoxypropylene diamines; poly(ethylene oxide capped oxypropylene) ether diamines; propylene oxide-based triamines; triethyleneglycoldiamines; trimethylolpropane-based triamines; glycerin-based triamines; and mixtures thereof. In one embodiment, the polyether amine used to form the prepolymer is JEFFAMINE® D2000, manufactured by Huntsman Chemical Co. of Austin, Tex.

The molecular weight of the polyether amine for use in the polyurea prepolymer may range from about 100 to about 5000. In one embodiment, the polyether amine molecular weight is about 200 or greater, preferably about 230 or greater. In another embodiment, the molecular weight of the polyether amine is about 4000 or less. In yet another embodiment, the molecular weight of the polyether amine is about 600 or greater. In still another embodiment, the molecular weight of the polyether amine is about 3000 or less. In yet another embodiment, the molecular weight of the polyether amine is between about 1000 and about 3000, and more preferably is between about 1500 to about 2500. Because lower molecular weight polyether amines may be prone to forming solid polyureas, a higher molecular weight oligomer, such as Jeffamine D2000, is preferred.

In one embodiment, the polyether amine has the generic structure:

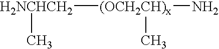

wherein the repeating unit x has a value ranging from about 1 to about 70. Even more preferably, the repeating unit may be from about 5 to about 50, and even more preferably is from about 12 to about 35.

In another embodiment, the polyether amine has the generic structure:

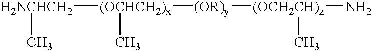

wherein the repeating units x and z have combined values from about 3.6 to about 8 and the repeating unit y has a value ranging from about 9 to about 50, and wherein R is —(CH₂)ₐ—, where “a” may be a repeating unit ranging from about 1 to about 10.

In yet another embodiment, the polyether amine has the generic structure:

H₂N—(R)—O—(R)—O—(R)—NH₂

wherein R is —(CH₂)ₐ—, and “a” may be a repeating unit ranging from about 1 to about 10.

As briefly discussed above, some amines may be unsuitable for reaction with the isocyanate because of the rapid reaction between the two components. In particular, shorter chain amines are fast reacting. In one embodiment, however, a hindered secondary diamine may be suitable for use in the prepolymer. Without being bound to any particular theory, it is believed that an amine with a high level of stearic hindrance, e.g., a tertiary butyl group on the nitrogen atom, has a slower reaction rate than an amine with no hindrance or a low level of hindrance. For example, 4,4′-bis-(sec-butylamino)-dicyclohexylmethane (CLEARLINK® 1000) may be suitable for use in combination with an isocyanate to form the polyurea prepolymer.

Any isocyanate available to one of ordinary skill in the art is suitable for use in the polyurea prepolymer. Isocyanates for use with the present invention include aliphatic, cycloaliphatic, araliphatic, aromatic, any derivatives thereof, and combinations of these compounds having two or more isocyanate (NCO) groups per molecule. The isocyanates may be organic polyisocyanate-terminated prepolymers. The isocyanate-containing reactable component may also include any isocyanate-functional monomer, dimer, trimer, or multimeric adduct thereof, prepolymer, quasi-prepolymer, or mixtures thereof. Isocyanate-functional compounds may include monoisocyanates or polyisocyanates that include any isocyanate functionality of two or more.

Suitable isocyanate-containing components include diisocyanates having the generic structure: O═C═N—R—N═C═O, where R is preferably a cyclic, aromatic, or linear or branched hydrocarbon moiety containing from about 1 to about 20 carbon atoms. The diisocyanate may also contain one or more cyclic groups or one or more phenyl groups. When multiple cyclic or aromatic groups are present, linear and/or branched hydrocarbons containing from about 1 to about 10 carbon atoms can be present as spacers between the cyclic or aromatic groups. In some cases, the cyclic or aromatic group(s) may be substituted at the 2-, 3-, and/or 4-positions, or at the ortho-, meta-, and/or para-positions, respectively. Substituted groups may include, but are not limited to, halogens, primary, secondary, or tertiary hydrocarbon groups, or a mixture thereof.

Examples of diisocyanates that can be used with the present invention include, but are not limited to, substituted and isomeric mixtures including 2,2′-, 2,4′-, and 4,4′-diphenylmethane diisocyanate; 3,3′-dimethyl-4,4′-biphenylene diisocyanate; toluene diisocyanate; polymeric MDI; carbodiimide-modified liquid 4,4′-diphenylmethane diisocyanate; p-phenylene diisocyanate; m-phenylene diisocyanate; triphenyl methane-4,4′- and triphenyl methane-4,4′-triisocyanate; naphthylene-1,5-diisocyanate; 2,4′-, 4,4′-, and 2,2-biphenyl diisocyanate; polyphenyl polymethylene polyisocyanate; mixtures of MDI and PMDI; mixtures of PMDI and TDI; ethylene diisocyanate; propylene-1,2-diisocyanate; tetramethylene-1,2-diisocyanate; tetramethylene-1,3-diisocyanate; tetramethylene-1,4-diisocyanate; 1,6-hexamethylene-diisocyanate; octamethylene diisocyanate; decamethylene diisocyanate; 2,2,4-trimethylhexamethylene diisocyanate; 2,4,4-trimethylhexamethylene diisocyanate; dodecane-1,12-diisocyanate; cyclobutane-1,3-diisocyanate; cyclohexane-1,2-diisocyanate; cyclohexane-1,3-diisocyanate; cyclohexane-1,4-diisocyanate; methyl-cyclohexylene diisocyanate; 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate; triisocyanate of HDI; triisocyanate of 2,2,4-trimethyl-1,6-hexane diisocyanate; 4,4′-dicyclohexylmethane diisocyanate; 2,4-hexahydrotoluene diisocyanate; 2,6-hexahydrotoluene diisocyanate; 1,2-, 1,3-, and 1,4-phenylene diisocyanate; aromatic aliphatic isocyanate, such as 1,2-, 1,3-, and 1,4-xylene diisocyanate; m-tetramethylxylene diisocyanate; p-tetramethylxylene diisocyanate; trimerized isocyanurate of any polyisocyanate, such as isocyanurate of toluene diisocyanate, trimer of diphenylmethane diisocyanate, trimer of tetramethylxylene diisocyanate, isocyanurate of hexamethylene diisocyanate, isocyanurate of isophorone diisocyanate, and mixtures thereof, dimerized uredione of any polyisocyanate, such as uretdione of toluene diisocyanate, uretdione of hexamethylene diisocyanate, and mixtures thereof, modified polyisocyanate derived from the above isocyanates and polyisocyanates; and mixtures thereof.

The number of unreacted NCO groups in the polyurea prepolymer of isocyanate and polyether amine may be varied to control such factors as the speed of the reaction, the resultant hardness of the composition, and the like. For instance, the number of unreacted NCO groups in the polyurea prepolymer of isocyanate and polyether amine may be less than about 14 percent. In one embodiment, the polyurea prepolymer has from about 5 percent to about 11 percent unreacted NCO groups, and even more preferably has from about 6 to about 9.5 percent unreacted NCO groups. In one embodiment, the percentage of unreacted NCO groups is about 3 percent to about 9 percent. Alternatively, the percentage of unreacted NCO groups in the polyurea prepolymer may be about 7.5 percent or less, and more preferably, about 7 percent or less. In another embodiment, the unreacted NCO content is from about 2.5 percent to about 7.5 percent, and more preferably from about 4 percent to about 6.5 percent.

When formed, polyurea prepolymers may contain about 10 percent to about 20 percent by weight of the prepolymer of free isocyanate monomer. Thus, in one embodiment, the polyurea prepolymer may be stripped of the free isocyanate monomer. For example, after stripping, the prepolymer may contain about 1 percent or less free isocyanate monomer. In another embodiment, the prepolymer contains about 0.5 percent by weight or less of free isocyanate monomer.

The polyether amine may be blended with additional polyols to formulate copolymers that are reacted with excess isocyanate to form the polyurea prepolymer. In one embodiment, less than about 30 percent polyol by weight of the copolymer is blended with the saturated polyether amine. In another embodiment, less than about 20 percent polyol by weight of the copolymer, preferably less than about 15 percent by weight of the copolymer, is blended with the polyether amine. The polyols listed above with respect to the polyurethane prepolymer, e.g., polyether polyols, polycaprolactone polyols, polyester polyols, polycarbonate polyols, hydrocarbon polyols, other polyols, and mixtures thereof, are also suitable for blending with the polyether amine. The molecular weight of these polymers may be from about 200 to about 4000, but also may be from about 1000 to about 3000, and more preferably are from about 1500 to about 2500.

The polyurea composition can be formed by crosslinking the polyurea prepolymer with a single curing agent or a blend of curing agents. The curing agent of the invention is preferably an amine-terminated curing agent, more preferably a secondary diamine curing agent so that the composition contains only urea linkages. In one embodiment, the amine-terminated curing agent may have a molecular weight of about 64 or greater. In another embodiment, the molecular weight of the amine-curing agent is about 2000 or less. As discussed above, certain amine-terminated curing agents may be modified with a compatible amine-terminated freezing point depressing agent or mixture of compatible freezing point depressing agents.

Suitable amine-terminated curing agents include, but are not limited to, ethylene diamine; hexamethylene diamine; 1-methyl-2,6-cyclohexyl diamine; tetrahydroxypropylene ethylene diamine; 2,2,4- and 2,4,4-trimethyl-1,6-hexanediamine; 4,4′-bis-(sec-butylamino)-dicyclohexylmethane; 1,4-bis-(sec-butylamino)-cyclohexane; 1,2-bis-(sec-butylamino)-cyclohexane; derivatives of 4,4′-bis-(sec-butylamino)-dicyclohexylmethane; 4,4′-dicyclohexylmethane diamine; 1,4-cyclohexane-bis-(methylamine); 1,3-cyclohexane-bis-(methylamine); diethylene glycol di-(aminopropyl)ether; 2-methylpentamethylene-diamine; diaminocyclohexane; diethylene triamine; triethylene tetramine; tetraethylene pentamine; propylene diamine; 1,3-diaminopropane; dimethylamino propylamine; diethylamino propylamine; dipropylene triamine; imido-bis-propylamine; monoethanolamine, diethanolamine; triethanolamine; monoisopropanolamine, diisopropanolamine; isophoronediamine; 4,4′-methylenebis-(2-chloroaniline); 3,5;dimethylthio-2,4-toluenediamine; 3,5-dimethylthio-2,6-toluenediamine; 3,5-diethylthio-2,4-toluenediamine; 3,5;diethylthio-2,6-toluenediamine; 4,4′-bis-(sec-butylamino)-diphenylmethane and derivatives thereof; 1,4-bis-(sec-butylamino)-benzene; 1,2-bis-(sec-butylamino)-benzene; N,N′-dialkylamino-diphenylmethane; N,N,N′,N′-tetrakis(2-hydroxypropyl)ethylene diamine; trimethyleneglycol-di-p-aminobenzoate; polytetramethyleneoxide-di-p-aminobenzoate; 4,4′-methylenebis-(3-chloro-2,6-diethyleneaniline); 4,4′-methylenebis-(2,6-diethylaniline); meta-phenylenediamine; paraphenylenediamine; and mixtures thereof. In one embodiment, the amine-terminated curing agent is 4,4′-bis-(sec-butylamino)-dicyclohexylmethane.

A particularly preferred embodiment includes an outer cover layer formed from a blend of microgels and a thermosetting polyurethane or polyurea, which results in improvement of one or more of resilience, moisture resistance, toughness, cut resistance, shear or scuff resistance, increased coefficient of friction, and increased spin rates.

Other suitable materials useful in forming the cover and/or intermediate layer(s) of the golf balls of the invention include ionic or non-ionic polyurethanes and polyureas, epoxy resins, polyethylenes, polyamides and polyesters. For example, the cover and/or intermediate layer may be formed from a blend of at least one saturated polyurethane and thermoplastic or thermoset ionic and non-ionic urethanes and polyurethanes, cationic urethane ionomers and urethane epoxies, ionic and non-ionic polyureas and blends thereof. Examples of suitable urethane ionomers are disclosed in U.S. Pat. No. 5,692,974, the disclosure of which is hereby incorporated by reference in its entirety. Other examples of suitable polyurethanes are described in U.S. Pat. No. 5,334,673. Examples of appropriate polyureas are discussed in U.S. Pat. No. 5,484,870 and examples of suitable polyurethanes cured with epoxy group containing curing agents are disclosed in U.S. Pat. No. 5,908,358, the disclosures of which are hereby incorporated herein by reference in their entirety.

A variety of conventional components can be added to the cover compositions of the present invention. These include, but are not limited to, white pigment such as TiO₂, ZnO, optical brighteners, surfactants, processing aids, foaming agents, density-controlling fillers, UV stabilizers and light stabilizers. Saturated polyurethanes are resistant to discoloration. However, they are not immune to deterioration in their mechanical properties upon weathering. Addition of UV absorbers and light stabilizers therefore helps to maintain the tensile strength and elongation of the saturated polyurethane elastomers. Suitable UV absorbers and light stabilizers include TINUVIN® 328, TINUVIN® 213, TINUVIN® 765, TINUVIN® 770 and TINUVIN® 622. The preferred UV absorber is TINUVIN® 328, and the preferred light stabilizer is TINUVIN® 765. TINUVIN® products are available from Ciba-Geigy. Dyes, as well as optical brighteners and fluorescent pigments may also be included in the golf ball covers produced with polymers formed according to the present invention. Such additional ingredients may be added in any amounts that will achieve their desired purpose.

Any method known to one of ordinary skill in the art may be used to form the polyurethanes. One commonly employed method, known in the art as a one-shot method, involves concurrent mixing of the polyisocyanate, polyol, and curing agent. This method results in a mixture that is inhomogenous (more random) and affords the manufacturer less control over the molecular structure of the resultant composition. A preferred method of mixing is known as a prepolymer method. In this method, the polyisocyanate and the polyol are mixed separately prior to addition of the curing agent. This method affords a more homogeneous mixture resulting in a more consistent polymer composition. Other methods suitable for forming the layers of the present invention include reaction injection molding (“RIM”), liquid injection molding (“LIM”), and pre-reacting the components to form an injection moldable thermoplastic polyurethane and then injection molding, all of which are known to one of ordinary skill in the art.

Additional components which can be added to the cover compositions include UV stabilizers and other dyes, as well as optical brighteners and fluorescent pigments and dyes. Such additional ingredients may be added in any amounts that will achieve their desired purpose. It has been found by the present invention that the use of a castable, reactive material, which is applied in a fluid form, makes it possible to obtain very thin outer cover layers on golf balls. Specifically, it has been found that castable, reactive liquids, which react to form a urethane or urea (or hybrids thereof) elastomer material, provide desirable very thin outer cover layers.

The castable, reactive liquid employed to form the urethane or urea (or hybrids thereof) elastomer materials can be applied over the core using a variety of application techniques such as spraying, dipping, spin coating, or flow coating methods which are well known in the art. An example of a suitable coating technique is that which is disclosed in U.S. Pat. No. 5,733,428, the disclosure of which is hereby incorporated by reference in its entirety.

The outer cover is preferably formed around the inner cover by mixing and introducing the material in the mold halves. It is important that the viscosity be measured over time, so that the subsequent steps of filling each mold half, introducing the core into one half and closing the mold can be properly timed for accomplishing centering of the core cover halves fusion and achieving overall uniformity. Suitable viscosity range of the curing urethane mix for introducing cores into the mold halves is determined to be approximately between about 2,000 cP and about 30,000 cP, with the preferred range of about 8,000 cP to about 15,000 cP.

To start the cover formation, mixing of the prepolymer and curative is accomplished in motorized mixer including mixing head by feeding through lines metered amounts of curative and prepolymer. Top preheated mold halves are filled and placed in fixture units using centering pins moving into holes in each mold. At a later time, a bottom mold half or a series of bottom mold halves have similar mixture amounts introduced into the cavity. After the reacting materials have resided in top mold halves for about 40 to about 80 seconds, a core is lowered at a controlled speed into the gelling reacting mixture.

A ball cup holds the ball core through reduced pressure (or partial vacuum). Upon location of the coated core in the halves of the mold after gelling for about 40 to about 80 seconds, the vacuum is released allowing core to be released. The mold halves, with core and solidified cover half thereon, are removed from the centering fixture unit, inverted and mated with other mold halves which, at an appropriate time earlier, have had a selected quantity of reacting polyurethane prepolymer and curing agent introduced therein to commence gelling.

Similarly, U.S. Pat. No. 5,006,297 to Brown et al. and U.S. Pat. No. 5,334,673 to Wu both also disclose suitable molding techniques which may be utilized to apply the castable reactive liquids employed in the present invention. Further, U.S. Pat. Nos. 6,180,040 and 6,180,722 disclose methods of preparing dual core golf balls. The disclosures of these patents are hereby incorporated by reference in their entirety. However, the method of the invention is not limited to the use of these techniques.

Ionomers may be blended with conventional ionomeric copolymers (di-, ter-, etc.), using well-known techniques, to manipulate product properties as desired. The blends would still exhibit lower hardness and higher resilience when compared with blends based on conventional ionomers.

Also, ionomers can be blended with non-ionic thermoplastic resins to manipulate product properties. The non-ionic thermoplastic resins would, by way of non-limiting illustrative examples, include thermoplastic elastomers, such as polyurethane, poly-ether-ester, poly-amide-ether, polyether-urea, PEBAX® (a family of block copolymers based on polyether-block-amide, commercially supplied by Atochem), styrene-butadiene-styrene (SBS) block copolymers, styrene(ethylene-butylene)-styrene block copolymers, etc., polyamide (oligomeric and polymeric), polyesters, polyolefins including PE, PP, E/P copolymers, etc., ethylene copolymers with various comonomers, such as vinyl acetate, (meth)acrylates, (meth)acrylic acid, epoxy-functionalized monomer, CO, etc., functionalized polymers with maleic anhydride grafting, epoxidization etc., elastomers, such as EPDM, metallocene catalyzed PE and copolymer, ground up powders of the thermoset elastomers, etc. Such thermoplastic blends comprise about 1% to about 99% by weight of a first thermoplastic and about 99% to about 1% by weight of a second thermoplastic.

The thermoplastic composition of this invention comprises a polymer which, when formed into a sphere that is 1.50 to 1.54 inches in diameter, has a coefficient of restitution (COR) when measured by firing the sphere at an initial velocity of 125 feet/second against a steel plate positioned 3 feet from the point where initial velocity and rebound velocity are determined and by dividing the rebound velocity from the plate by the initial velocity and an Atti compression of no more than 100.

In one embodiment, the formation of a golf ball starts with forming the inner core. The inner core, outer core, and the cover are formed by compression molding, by injection molding, or by casting. These methods of forming cores and covers of this type are well known in the art. The materials used for the inner and outer core, as well as the cover, are selected so that the desired playing characteristics of the ball are achieved. The inner and outer core materials have substantially different material properties so that there is a predetermined relationship between the inner and outer core materials, to achieve the desired playing characteristics of the ball.

In one embodiment, the inner core is formed of a first material having a first Shore D hardness, a first elastic modulus, a first specific gravity, and a first Bashore resilience. The outer core is formed of a second material having a second Shore D hardness, a second elastic modulus, a second specific gravity, and a second Bashore resilience. Preferably, the material property of the first material equals at least one selected from the group consisting of the first Shore D hardness differing from the second Shore D hardness by at least 10 points, the first elastic modulus differing from the second elastic modulus by at least 10%, the first specific gravity differing from the second specific gravity by at least 0.1, or a first Bashore resilience differing from the second Bashore resilience by at least 10%. It is more preferred that the first material have all of these material property relationships.

Moreover, it is preferred that the first material has the first Shore D hardness between about 30 and about 80, the first elastic modulus between about 5,000 psi and about 100,000 psi, the first specific gravity between about 0.8 and about 1.6, and the first Bashore resilience greater than 30%.

In another embodiment, the first Shore D hardness is less than the second Shore D hardness, the first elastic modulus is less than the second elastic modulus, the first specific gravity is less than the second specific gravity, and the first Bashore resilience is less than the second Bashore resilience. In another embodiment, the first material properties are greater than the second material properties. The relationship between the first and second material properties depends on the desired playability characteristics.

Suitable inner and outer core materials include HNP's neutralized with organic fatty acids and salts thereof, metal cations, or a combination of both, thermosets, such as rubber, polybutadiene, polyisoprene; thermoplastics, such as ionomer resins, polyamides or polyesters; or thermoplastic elastomers. Suitable thermoplastic elastomers include PEBAX®, HYTREL®, thermoplastic urethane, and KRATON®, which are commercially available from Elf-Atochem, DuPont, BF Goodrich, and Shell, respectively. The inner and outer core materials can also be formed from a castable material. Suitable castable materials include, but are not limited to, urethane, urea, epoxy, diols, or curatives.

The cover is selected from conventional materials used as golf ball covers based on the desired performance characteristics. The cover may be comprised of one or more layers. Cover materials such as ionomer resins, blends of ionomer resins, thermoplastic or thermoset urethanes, and balata, can be used as known in the art and discussed above. In other embodiments, additional layers may be added to those mentioned above or the existing layers may be formed by multiple materials.

When the core is formed with a fluid-filled center, the center is formed first then the inner core is molded around the center. Conventional molding techniques can be used for this operation. Then the outer core and cover are formed thereon, as discussed above. The fluid within the inner core can be a wide variety of materials including air, water solutions, liquids, gels, foams, hot-melts, other fluid materials and combinations thereof. The fluid is varied to modify the performance parameters of the ball, such as the moment of inertia or the spin decay rate. Examples of suitable liquids include either solutions such as salt in water, corn syrup, salt in water and corn syrup, glycol and water or oils. The liquid can further include pastes, colloidal suspensions, such as clay, barytes, carbon black in water or other liquid, or salt in water/glycol mixtures. Examples of suitable gels include water gelatin gels, hydrogels, water/methyl cellulose gels and gels comprised of copolymer rubber based materials such a styrene-butadiene-styrene rubber and paraffinic and/or naphthenic oil. Examples of suitable melts include waxes and hot melts. Hot-melts are materials which at or about normal room temperatures are solid but at elevated temperatures become liquid. A high melting temperature is desirable since the liquid core is heated to high temperatures during the molding of the inner core, outer core, and the cover. The liquid can be a reactive liquid system, which combines to form a solid. Examples of suitable reactive liquids are silicate gels, agar gels, peroxide cured polyester resins, two part epoxy resin systems and peroxide cured liquid polybutadiene rubber compositions.

The resultant golf balls typically have a coefficient of restitution of greater than about 0.7, preferably greater than about 0.75, and more preferably greater than about 0.78. The golf balls also typically have an Atti compression of at least about 40, preferably from about 50 to 120, and more preferably from about 60 to 100. The golf ball cured polybutadiene material typically has a hardness of at least about 15 Shore A, preferably between about 30 Shore A and 80 Shore D, more preferably between about 50 Shore A and 60 Shore D.

Additionally, the unvulcanized rubber, such as polybutadiene, in golf balls prepared according to the invention typically has a Mooney viscosity of between about 40 and about 80, more preferably, between about 45 and about 65, and most preferably, between about 45 and about 55. Mooney viscosity is typically measured according to ASTM-D1646.

When golf balls are prepared according to the invention, they typically will have dimple coverage greater than about 60 percent, preferably greater than about 65 percent, and more preferably greater than about 75 percent. The flexural modulus of the cover on the golf balls, as measured by ASTM method D6272-98, Procedure B, is typically greater than about 500 psi, and is preferably from about 500 psi to 150,000 psi. As discussed herein, the outer cover layer is preferably formed from a relatively soft polyurethane material. In particular, the material of the outer cover layer should have a material hardness, as measured by ASTM-D2240, less than about 45 Shore D, preferably less than about 40 Shore D, more preferably between about 25 and about 40 Shore D, and most preferably between about 30 and about 40 Shore D. The casing preferably has a material hardness of less than about 70 Shore D, more preferably between about 30 and about 70 Shore D, and most preferably, between about 50 and about 65 Shore D.

In a preferred embodiment, the intermediate layer material hardness is between about 40 and about 70 Shore D and the outer cover layer material hardness is less than about 40 Shore D. In a more preferred embodiment, a ratio of the intermediate layer material hardness to the outer cover layer material hardness is greater than 1.5.

It should be understood, especially to one of ordinary skill in the art, that there is a fundamental difference between “material hardness” and “hardness, as measured directly on a golf ball.” Material hardness is defined by the procedure set forth in ASTM-D2240 and generally involves measuring the hardness of a flat “slab” or “button” formed of the material of which the hardness is to be measured. Hardness, when measured directly on a golf ball (or other spherical surface) is a completely different measurement and, therefore, results in a different hardness value. This difference results from a number of factors including, but not limited to, ball construction (i.e., core type, number of core and/or cover layers, etc.), ball (or sphere) diameter, and the material composition of adjacent layers. It should also be understood that the two measurement techniques are not linearly related and, therefore, one hardness value cannot easily be correlated to the other.

In one embodiment, the core of the present invention has an Atti compression of between about 50 and about 90, more preferably, between about 60 and about 85, and most preferably, between about 65 and about 85. The overall outer diameter (“OD”) of the core is less than about 1.590 inches, preferably, no greater than 1.580 inches, more preferably between about 1.540 inches and about 1.580 inches, and most preferably between about 1.525 inches to about 1.570 inches. The OD of the casing of the golf balls of the present invention is preferably between 1.580 inches and about 1.640 inches, more preferably between about 1.590 inches to about 1.630 inches, and most preferably between about 1.600 inches to about 1.630 inches.

The present multilayer golf ball can have an overall diameter of any size. Although the United States Golf Association specifications limit the minimum size of a competition golf ball to 1.680 inches. There is no specification as to the maximum diameter. Golf balls of any size, however, can be used for recreational play. The preferred diameter of the present golf balls is from about 1.680 inches to about 1.800 inches. The more preferred diameter is from about 1.680 inches to about 1.760 inches. The most preferred diameter is about 1.680 inches to about 1.740 inches.

The compositions of the present invention may also be used in golf equipment, in particular, inserts for golf clubs, such as putters, irons, and woods, and in golf shoes and components thereof.

As used herein, the term “about,” used in connection with one or more numbers or numerical ranges, should be understood to refer to all such numbers, including all numbers in a range.

Other than in the operating examples, or unless otherwise expressly specified, all of the numerical ranges, amounts, values and percentages such as those for amounts of materials, and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

The invention described and claimed herein is not to be limited in scope by the specific embodiments herein disclosed, since these embodiments are intended solely as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

What is claimed is:

1. A golf ball comprising:
a core;
an outer cover layer; and
an inner cover layer disposed between the core and outer cover layer, the inner cover layer comprising a polymer blend comprising a microgel having a T_{g} of 20° C. or greater formed from a monomer, a co-monomer, and an initiator; and a thermoplastic material.

2. The golf ball of claim 1, wherein the thermoplastic material is a conventional ionomer or a fully-neutralized ionomer.

3. The golf ball of claim 1, wherein the microgel is functionalized with a reactive group.

4. The golf ball of claim 3, wherein the reactive groups comprise hydroxyl, anhydrides, epoxies, isocyanates, amines, acids, amides, or nitrites.

5. The golf ball of claim 4, wherein the reactive groups comprise anhydride, hydroxyl, amines, isocyanates, or epoxies.

6. The golf ball of claim 1, wherein the cover is injection molded, cast, reaction injection molded, or compression molded.

7. The golf ball of claim 1, wherein the outer cover layer has material hardness of 60 Shore D or less.

8. The golf ball of claim 1, wherein the monomer comprises butadiene, styrene, esters of acrylic or methacrylic acid, acrylic or methacrylic acid, hydroxyethyl acrylate or hydroxyethyl methacrylate, or hydroxybutyl acrylate or hydroxybutyl methacrylate.

9. The golf ball of claim 1, wherein the co-monomer comprises neopentyl glycol, trimethylol propane, pentaerythlitol, triallyl trimellitate, divinyl benzene, di and triacrylates including urethane or urea diacrylate or methacrylate and triacrylate or methacrylate, or hydroxyl terminated polybutadiene.

10. The golf ball of claim 1, wherein the initiator comprises dicumyl peroxide; t-butylcumyl peroxide; bis-(t-butylperoxyisopropyl)benzene; di-t-butyl peroxide; 2,5-dimethylhexane-2,5-dihydroperoxide; 2,5-dimethylhexyne-3,2,5-dihydroperoxide; dibenzoyl peroxide; bis-(2,4-dichlorobenzoyl)peroxide; t-butyl perbenzoate; organic azo compounds; di- and polymercapto compounds; or mercapto-terminated polysulfide rubbers.

11. The golf ball of claim 10, wherein the initiator comprises dicumyl peroxide; t-butylcumyl peroxide; bis-(t-butylperoxyisopropyl)benzene; or di-t-butyl peroxide.

12. The golf ball of claim 1, wherein the T_{g} is from 40° C. to 70° C.

13. The golf ball of claim 1, wherein the microgel has a swelling index in toluene at 23° C. of 40 or less.

14. The golf ball of claim 1, wherein the microgel has an average particle diameter of 5 nm to 500 nm.

15. The golf ball of claim 14, wherein the microgel has an average particle diameter of 40 nm to 100 nm.

16. The golf ball of claim 1, wherein the core comprises a polybutadiene material or a fully-neutralized ionomer.

17. The golf ball of claim 1, wherein the core has an Atti compression of 50 to 100 and at least one of the inner cover layer or outer cover layer has a thickness of 0.020 inches to 0.045 inches.

18. A golf ball comprising:
a core comprising a center and an outer core layer, at lease one of the center or outer core layers comprising a polybutadiene rubber material or a fully-neutralized ionomeric material;
a castable polyurea or polyurethane outer cover layer having a thickness of 0.02 inches to 0.06 inches; and
an inner cover layer disposed between the core and outer cover layer, the inner cover layer having a thickness of 0.015 inches to 0.06 inches and comprising a polymer blend comprising a microgel having a T_{g} of 20° C. to 100° C. formed from a monomer, a co-monomer, and an initiator; and a thermoplastic material,
wherein the microgel is present in an amount of 2.5 phr to 25 phr and the outer core layer optionally comprises the microgel.

19. A golf ball comprising:
a core comprising a polybutadiene rubber material or a fully-neutralized ionomeric material;
a castable polyurea or polyurethane outer cover layer having a thickness of 0.02 inches to 0.06 inches; and
an inner cover layer disposed between the core and outer cover layer, the inner cover layer having a thickness of 0.015 inches to 0.06 inches and comprising a polymer blend comprising a second microgel having a T_{g} of 20° C. to 100° C. formed from a second monomer, a co-monomer, and a second initiator; and a thermoplastic material,
wherein the microgel is present in an amount of 2.5 phr to 25 phr.
